(19) United States
(12) Patent Application Publication
(10) Pub. No.: US 2026/0100769 A1
(43) Pub. Date: Apr. 9, 2026

(54) METHOD FOR DETERMINING SIGNAL QUALITY AND ASSOCIATED RECEIVER

(71) Applicant: MEDIATEK INC., Hsinchu City (TW)

(72) Inventors: Cheng-Tien Wan, Hsinchu City (TW); Po-Chao Tsao, Hsinchu City (TW); Wei-Chin Chang, Hsinchu City (TW); Chung-Hsuan Yang, Hsinchu City (TW); Han-Jung Huang, Hsinchu City (TW); Ming-Cheng Lee, Hsinchu City (TW); Tung-Hsing Lee, Hsinchu City (TW); Chi-Ming Lee, Hsinchu City (TW); Jonathan Perng, Hsinchu City (TW); Jui-Hsing Tseng, Hsinchu City (TW); Peng-Yu Chen, Hsinchu City (TW); Tse-Chung Li, Hsinchu City (TW); Chia-Hao Yang, Hsinchu City (TW)

(73) Assignee: MEDIATEK INC., Hsinchu City (TW)

(21) Appl. No.: 18/908,854

(22) Filed: Oct. 8, 2024

(51) Int. Cl. H04B 17/21; H04B 17/23; H04B 17/26

(52) U.S. Cl. CPC H04B 17/21; H04B 17/23; H04B 17/26

(57) ABSTRACT

A method for determining a signal quality includes: receiving a signal from a circuit device; generating multiple eye diagrams according to the signal; determining whether each eye diagram is normal according to a basic index to generate a first determination result, wherein the basic index comprises an eye height and an eye width; in response to the first determination result indicating that each diagram is normal, determining whether each eye diagram is normal according to an advanced index to generate a second determination result, wherein the advanced index comprises at least one of a combination of an area and a contour length, a combination of a density and a gradient, and a combination of multiple slopes; and in response to the second determination result indicating that each eye diagram is normal, determining the signal quality of the signal according to each of the multiple eye diagrams.

### BACKGROUND

The present disclosure is related to signal quality determination, and more particularly, to a method that can effectively and accurately determine the signal quality according to additional indices of the eye diagrams, and an associated receiver.

For a system on chip (SoC) or a memory that is equipped with a receiver, multiple eye diagrams may be generated according to a received signal by the receiver, for determining a signal quality of the received signal. Since directly checking certain characteristics of the eye diagrams through a user for signal quality determination is quite complicated, some characteristics of the eye diagrams are digitized to effectively perform the determination. For example, the signal quality may be determined based on whether the dimensions of the eye diagrams (e.g., an eye width or an eye height) meet the standards defined by the specification. For some extreme cases (e.g., eye diagrams with irregular shape), however, the determination may be wrong.

### SUMMARY

It is therefore one of the objectives of the present disclosure to provide a method that can effectively and accurately determine the signal quality according to additional indices of the eye diagrams, and an associated receiver, to solve the above-mentioned issues.

According to an embodiment of the present disclosure, a method for determining a signal quality is provided. The method comprises: receiving a signal from a circuit device; generating multiple eye diagrams according to the signal; determining whether each of the multiple eye diagrams is normal according to a basic index to generate a first determination result, wherein the basic index is derived from each of the multiple eye diagrams, and comprises an eye height and an eye width of each of the multiple eye diagrams; in response to the first determination result indicating that each of the multiple eye diagrams is normal, determining whether each of the multiple eye diagrams is normal according to an advanced index to generate a second determination result, wherein the advanced index is derived from each of the multiple eye diagrams, and comprises at least one of a combination of an area and a contour length of each of the multiple eye diagrams, a combination of a density and a gradient of each of the multiple eye diagrams, and a combination of multiple slopes of each of the multiple eye diagrams; and in response to the second determination result indicating that each of the multiple eye diagrams is normal, determining the signal quality of the signal according to each of the multiple eye diagrams.

According to an embodiment of the present disclosure, a receiver is provided. The receiver is arranged to: receive a signal from a circuit device; generate multiple eye diagrams according to the signal; determine whether each of the multiple eye diagrams is normal according to a basic index to generate a first determination result, wherein the basic index is derived from each of the multiple eye diagrams, and comprises an eye height and an eye width of each of the multiple eye diagrams; in response to the first determination result indicating that each of the multiple eye diagrams is normal, determine whether each of the multiple eye diagrams is normal according to an advanced index to generate a second determination result, wherein the advanced index is derived from each of the multiple eye diagrams, and comprises at least one of a combination of an area and a contour length of each of the multiple eye diagrams, a combination of a density and a gradient of each of the multiple eye diagrams, and a combination of multiple slopes of each of the multiple eye diagrams; and in response to the second determination result indicating that each of the multiple eye diagrams is normal, determine the signal quality of the signal according to each of the multiple eye diagrams.

One of the benefits of the present disclosure is that, by the method and the receiver of the present disclosure, the eye diagrams can be determined to be normal or not to generate a determination result according to both the basic index and the advanced index, and the signal quality of the received signal can be effectively and accurately determined according to the determination result. Compared with a case where the signal quality of the received signal is determined only according to a determination result obtained only according to the basic index, the method and the receiver of the present disclosure can effectively detect the failure of data access operations performed upon the received signal regarding extreme cases (e.g., eye diagrams with irregular shape).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory system according to an embodiment of the present disclosure.

FIG. 2 is a diagram illustrating mapping between eye diagrams and a two-dimensional coordinate system according to an embodiment of the present disclosure, wherein the two-dimensional coordinate system has a horizontal axis showing an area, and a vertical axis showing a contour length.

FIG. 3 is a diagram illustrating mapping between an eye diagram and a two-dimensional coordinate system according to an embodiment of the present disclosure, wherein the two-dimensional coordinate system has a horizontal axis showing a time, and a vertical axis showing a voltage amplitude.

FIG. 4 is a diagram illustrating two tables derived from the two-dimensional coordinate system shown in FIG. 3 for obtaining a gradient value of the eye diagram according to an embodiment of the present disclosure.

FIG. 5 is a diagram illustrating multiple slopes corresponding to multiple rising times and multiple falling times of an eye diagram according to an embodiment of the present disclosure.

FIG. 6 is a flow chart of a method for determining a signal quality according to an embodiment of the present disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

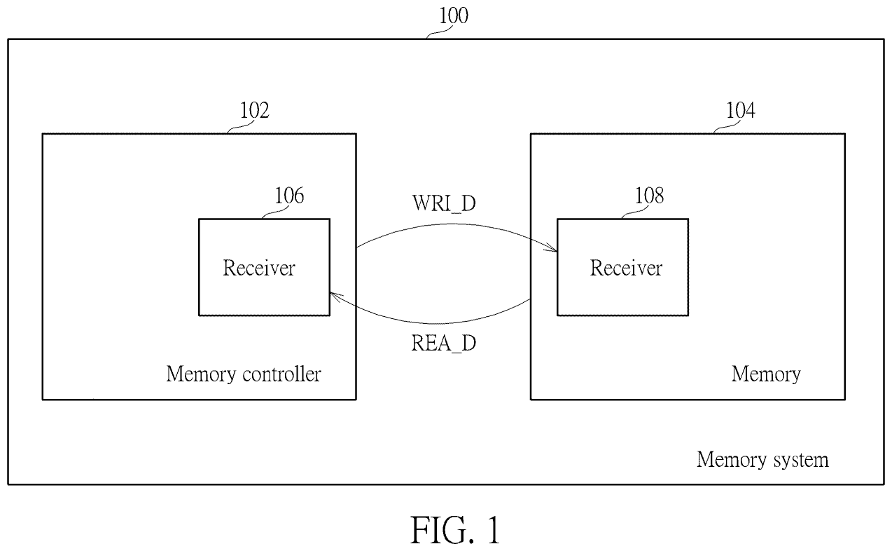

FIG. 1 is a diagram illustrating a memory system 100 according to an embodiment of the present disclosure. The memory system 100 is only an example and is not meant to be a limitation of the present disclosure. The solution of the embodiment of the present disclosure can be used in other circuits, such as any circuit with a receiver, to generate an eye diagram for a received signal and perform detection and determination. As show in FIG. 1, the memory system 100 may include a memory controller 102 and a memory (e.g., a dynamic random access memory, DRAM) 104, wherein the memory controller 102 may be implemented by a system on chip (SoC; e.g., the memory controller 102 may be included in the SoC). The memory controller 102 may include a receiver 106 for receiving a signal (e.g., read data REA_D) from the memory 104 in response to a read command from a host device (not shown in FIG. 1), wherein the receiver 106 may conform to a double data rate (DDR) communications specification. The memory 104 may include a receiver 108 for receiving a signal (e.g., write data WRI_D) from the memory controller 102 in response to a write command from the host device, wherein the receiver 108 may conform to the DDR communications specification, and the memory 104 may perform communications with the memory controller 102 according to the DDR communications specification. Since operations of the receiver 108 are similar to that of the receiver 106, the following paragraphs focus on the operations of the receiver 106 regarding the read data REA_D, and similar descriptions for the operations of the receiver 108 regarding the write data WRI_D are omitted here for brevity.

After receiving the read data REA_D, the receiver 106 may be further arranged to generate multiple eye diagrams ED_1-ED_M according to the read data REA_D, and determine whether each of the eye diagrams ED_1-ED_M is normal according to a basic index BA_I to generate a first determination result F_DR for determining a signal quality of the received signal (e.g., a data quality of the read data REA_D), wherein “M” may be an integer greater than 1, and the basic index BA_I may be derived from each of the eye diagrams ED_1-ED_M, and may include an eye height and an eye width of each of the eye diagrams ED_1-ED_M. For example, the receiver 106 may determine whether the basic index BA_I meets the standard defined by the specification to determine whether a corresponding eye diagram is normal.

In response to the first determination result F_DR indicating that an eye diagram is abnormal (i.e., the basic index BA_I of the eye diagram does not meet the standard), the failure of the data access operations performed upon the read data REA_D (hereinafter referred to as “DDR failure” for brevity) cannot be effectively detected through the eye diagram. The receiver 106 may notify the memory controller 102 (more particularly, a transmission terminal of the memory controller 102) which parameters required to be tuned/adjusted according to the first determination result F_DR. For example, the memory controller 102 may tune/adjust parameters associated with internal components (e.g., multiple transistors) of the SoC including the memory controller 102 to adjust a supply voltage supplied to the transistors, such that the driving ability of the transistors can become stable. In addition, since the high-speed data transmission between the memory controller 102 and the memory 104 may suffer from impedance mismatch problems, the receiver 106 may notify the memory controller 102 to tune/adjust parameters associated with the impedances. Furthermore, in some embodiments, the receiver 106 may be further arranged to notify the memory controller 102 to reboot the memory system 100, or send a warning signal to a user interface (e.g., a screen) due to the DDR failure.

As mentioned in the above, for some extreme cases (e.g., eye diagrams with irregular shape), however, the first determination result F_DR may be wrong. As a result, in response to the first determination result F_DR indicating that the eye diagram is normal, the receiver 106 may be further arranged to determine whether each of the eye diagrams ED_1-ED_M is normal according to an advanced index AD_I to generate a second determination result S_DR, wherein the advanced index AD_I may include at least one of a combination of an area and a contour length of each of the eye diagrams ED_1-ED_M (hereinafter labeled as “combination COM_1” for brevity), a combination of a density and a gradient of each of the eye diagrams ED_1-ED_M (hereinafter labeled as “combination COM_2” for brevity), and a combination of multiple slopes of each of the eye diagrams ED_1-ED_M (hereinafter labeled as “combination COM_3”for brevity).

For example, the advanced index AD_I may only include the combination COM_1, and the second determination result S_DR is generated according to the combination COM_1. For another example, the advanced index AD_I may include both the combinations COM_1 and COM_2, and the second determination result S_DR is generated according to the combinations COM_1 and COM_2. For still another example, the advanced index AD_I may include all of the combinations COM_1, COM_2, and COM_3, and the second determination result S_DR is generated according to the combinations COM_1, COM_2, and COM_3. However, this is for illustrative purposes only, and is not meant to be as a limitation of the present disclosure.

The receiver 106 may determine the signal quality of the received signal (e.g., the data quality of the read data REA_D) according to the second determination result S_DR. Compared with a case where the signal quality of the received signal is determined only according to the first determination result F_DR, the receiver 106 of the present disclosure can effectively detect the DDR failure regarding extreme cases (e.g., eye diagrams with irregular shape) through the additional second determination result S_DR. In addition, the receiver 106 may be further arranged to notify the memory controller 102 which parameters required to be tuned/adjusted according to the second determination result S_DR. Since the parameter tuning/adjustment operations for the second determination result S_DR are similar to that for the first determination result F_DR, similar descriptions are not repeated here for brevity.

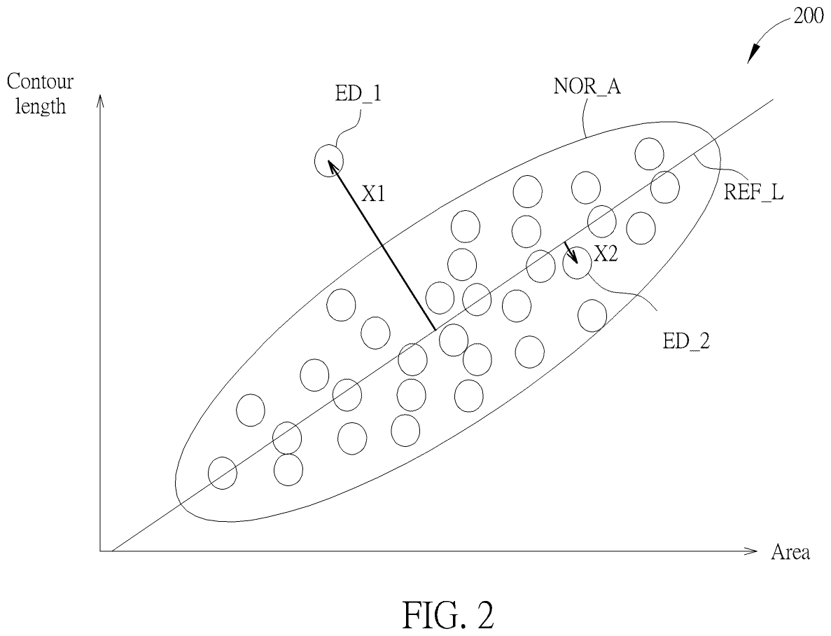

FIG. 2 is a diagram illustrating mapping between the eye diagrams ED_1-ED_M and a two-dimensional coordinate system 200 according to an embodiment of the present disclosure, wherein the two-dimensional coordinate system 200 has a horizontal axis showing an area, and a vertical axis showing a contour length. In ideal, an area of an eye diagram may be positively related to (e.g., proportional to) a contour length of the eye diagram. Therefore, an eye diagram with an abnormally large contour length among multiple eye diagrams with the same or similar areas may be regarded as an abnormal eye diagram with an abnormal shape.

In this embodiment, the advanced index AD_I is the combination COM_1 (i.e., the combination of the area and the contour length of each of the eye diagrams ED_1-ED_M). The receiver 106 may map each of the eye diagrams ED_1-ED_M to a mapping point on the two-dimensional coordinate system 200 (for brevity, only the eye diagrams ED_1 and ED_2 are labeled in FIG. 2). Specifically, the receiver 106 may calculate a distance between each of multiple mapping points and a reference line REF_L to generate multiple calculation results (e.g., a distance X1 corresponding to a mapping point mapped to the eye diagram ED_1 and a distance X2 corresponding to a mapping point mapped to the eye diagram ED_2), and calculate a standard deviation STD according to the multiple calculation results, wherein the multiple mapping points correspond to the eye diagrams ED_1-ED_M, respectively, and the reference line REF_L is formed by connecting multiple predetermined points that are obtained by referring to large amounts of data. The multiple predetermined points can be obtained based on relatively normal eye patterns in historical data.

Afterwards, the receiver 106 may determine whether each of the eye diagrams ED_1-ED_M is normal according to a corresponding calculation result among the multiple calculation results and the standard deviation STD. Specifically, the receiver 106 may determine whether the corresponding calculation result is larger than a threshold value THV_1 for determining whether each of the eye diagrams ED_1-ED_M is normal, wherein the threshold value THV_1 may be equal to the standard deviation STD multiplying by a predetermined constant C (i.e., THV_1=STD*C), and may correspond to a normal area NOR_A, wherein the predetermined constant C may be determined depending upon actual design requirements.

Under a condition that the corresponding calculation result being larger than the threshold value THV_1, the mapping point corresponding to each of the eye diagrams ED_1-ED_M will be out of the normal area NOR_A, and the receiver 106 determines each of the eye diagrams ED_1-ED_M is not normal. Take the eye diagram ED_1 as an example. Since the mapping point corresponding to the eye diagram ED_1 is out of the normal area NOR_A (i.e., the calculation result of the eye diagram ED_1 such as the distance X1 is larger than the threshold value THV_1), the eye diagram ED_1 is determined to be not normal.

Under a condition that the corresponding calculation result not being larger than the threshold value THV_1, the mapping point corresponding to each of the eye diagrams ED_1-ED_M will be within the normal area NOR_A, and the receiver 106 determines each of the eye diagrams ED_1-ED_M is normal. Take the eye diagram RD_2 as an example. Since the mapping point corresponding to the eye diagram ED_2 is within the normal area NOR_A (i.e., the calculation result of the eye diagram ED_2 such as the distance X2 is not larger than the threshold value THV_1), the eye diagram ED_2 is determined to be normal.

For a normal eye diagram, the data access operation performed upon data corresponding to an internal area of the eye diagram is successful (hereinafter referred to as “DDR pass” for brevity), and the data access operation performed upon data corresponding to an external area of the eye diagram fails (e.g., the DDR failure). For an abnormal eye diagram, near a boundary area of the eye diagram, the DDR failure may happen in some portions of the internal area of the eye diagram, and the DDR pass may happen in some portions of the external area of the eye diagram. In order to address this issue, the advanced index AD_I may be the combination COM_2 (i.e., the combination of the density and the gradient of each of the eye diagrams ED_1-ED_M).

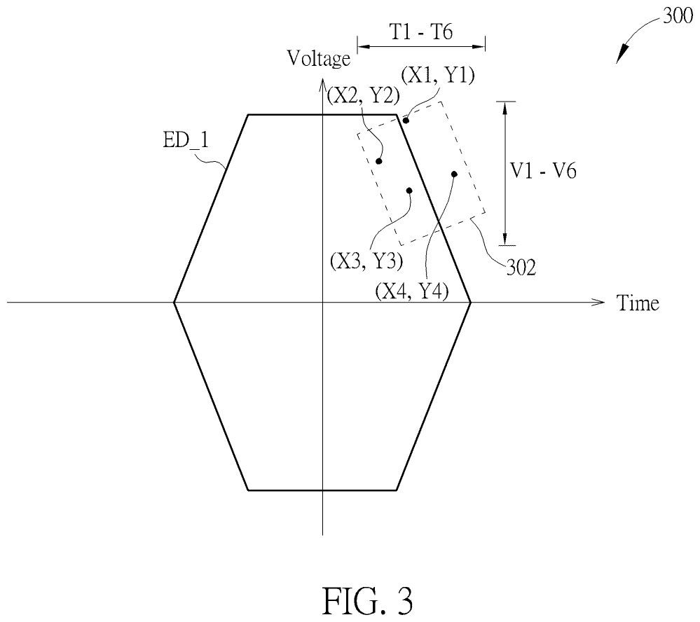

FIG. 3 is a diagram illustrating mapping between an eye diagram (e.g., the eye diagram ED_1) and a two-dimensional coordinate system 300 according to an embodiment of the present disclosure, wherein the two-dimensional coordinate system 300 has an origin at a center of the eye diagram ED_1, a horizontal axis showing a time, and a vertical axis showing a voltage amplitude. The receiver 106 may map each of the eye diagrams ED_1-ED_M (e.g., the eye diagram ED_1) to the two-dimensional coordinate system 300, and perform a division operation upon the two-dimensional coordinate system 300 according to a predetermined time interval (e.g., a time interval T1-T6) and multiple predetermined voltage amplitude values (e.g., voltage amplitude values V1-V6) to obtain a data array 302, wherein the data array 302 is located at a boundary area of the eye diagram ED_1, and includes a portion of internal areas of the eye diagram ED_1 that is within the boundary area and a portion of external areas of the eye diagram ED_1 that is out of the boundary area. The data array 302 may include multiple data within the portion of the internal areas of the eye diagram ED_1 and multiple data within the portion of the external areas of the eye diagram ED_1, wherein only 4 data (a first data (X1, Y1), a second data (X2, Y2), a third data (X3, Y3), and a fourth data (X4, Y4)) within the data array 302 are shown in FIG. 3 for brevity.

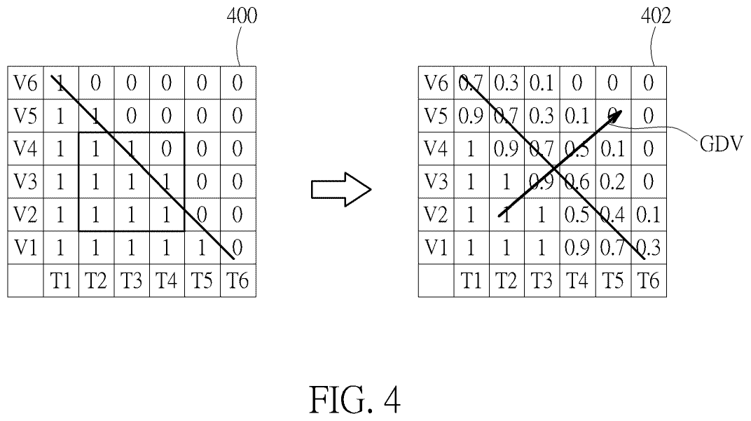

Afterwards, the receiver 106 may set a setting value of each data within the data array 302 as a first level or a second level according to whether a data access operation performed upon each data fails, wherein the first level is different from the second level. For example, in response to the data access operation performed upon a data failing, the receiver 106 may set the setting value of the data as a low level (e.g., a logical value “0”). In response to the data access operation performed upon a data not failing, the receiver 106 may set the setting value of the data as a high level (e.g., a logical value “1”). Specifically, refer to FIG. 4. FIG. 4 is a diagram illustrating two tables 400 and 402 derived from the two-dimensional coordinate system 300 shown in FIG. 3 for obtaining a gradient value GDV of the eye diagram ED_1 according to an embodiment of the present disclosure, wherein the gradient value GDV may be arranged to determine whether the eye diagram ED_1 is normal. The table 400 illustrates the setting value of each data within the data array 302. In order to obtain the gradient value GDV, the receiver 106 may calculate a density value DSV of each data within the data array 302 according to multiple setting values of the data within the data array 302, wherein the multiple setting values include the setting value of each data and another setting values of multiple adjacent data with respect to each data, and the multiple adjacent data are within the data array 302. Specifically, the receiver 106 may perform an average operation upon the multiple setting values to generate the density value DSV of each data.

Take the third data (X3, Y3) as an example. The third data (X3, Y3) corresponds to a point (T3, V3) with a setting value of 1 in the table 400. The receiver 106 may perform an average operation upon the setting value corresponding to the third data (X3, Y3) and setting values corresponding to 8 adjacent data with respect to the third data (X3, Y3), to obtain the density value DSV with a value of 0.9 (e.g., DSV=(1+1+0+1+1+1+1+1+1)/9=0.9) for the third data (X3, Y3).

Take the fourth data (X4, Y4) as another example. The fourth data (X4, Y4) corresponds to a point (T4, V4) with a setting value of 0 in the table 400. The receiver 106 may perform an average operation upon the setting value corresponding to the fourth data (X4, Y4) and setting values corresponding to 8 adjacent data with respect to the fourth data (X4, Y4), to obtain the density value DSV with a value of 0.3 (e.g., DSV=(0+0+0 30 1+0+0+1+1+0)/9=0.3) for the fourth data (X4, Y4).

The table 402 illustrates the density value DSV of each data within the data array 302. After obtaining multiple density values {DSV} of the data within the data array 302, the receiver 106 may calculate the gradient value GDV according to the density values {DSV}, wherein the gradient value GDV is a slope of the density values {DSV}, and the density values {DSV} include at least one density value within the boundary area (e.g., the density value DSV corresponding to the third data (X3, Y3) within the portion of internal areas of the eye diagram ED_1) and at least one density value out of the boundary area (e.g., the density value DSV corresponding to the fourth data (X4, Y4) within the portion of external areas of the eye diagram ED_1). In response to the gradient value GDV indicating that variation amplitude of the density values {DSV} is larger than a threshold value THV_2, the receiver 106 may determine that the eye diagram ED_1 is normal, wherein the threshold value THV_2 may be determined depending upon actual design requirements. In response to the gradient value GDV indicating that the variation amplitude of the density values {DSV} is not larger than the threshold value THV_2, the receiver 106 may determine that the eye diagram ED_1 is not normal. Since the operations of obtaining gradient value GDV for the eye diagrams ED_2-ED_M are similar to that for the eye diagram ED_1, similar descriptions for the eye diagrams ED_2-ED_M are not repeated in detail here.

The rising/falling time of an eye diagram with respect to a horizontal straight line passing through a center of the eye diagram (i.e., a corresponding angle/slope) is related to the driving ability of the internal components (e.g., the transistors) of the SoC including the memory controller 102. If the driving ability is poor, the corresponding angle/slope will be smaller, which may cause the eye height of the eye diagram to fail to meet the standard of the specification.

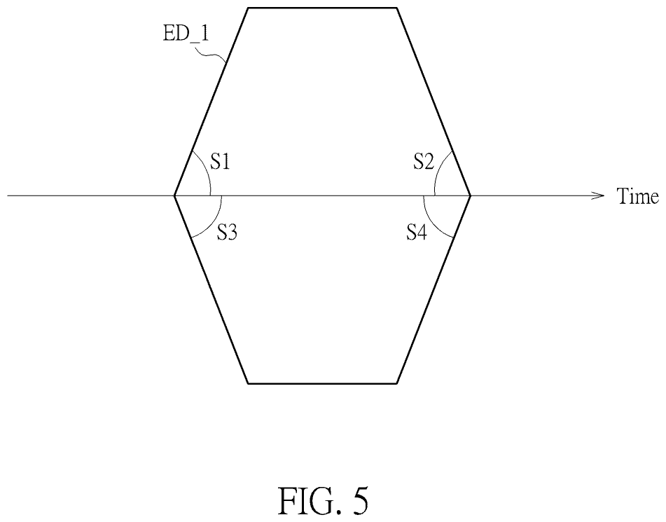

FIG. 5 is a diagram illustrating multiple slopes S1 and S4 corresponding to multiple rising times and multiple slopes S2 and S3 corresponding to multiple falling times of an eye diagram (e.g., the eye diagram ED_1) according to an embodiment of the present disclosure. In this embodiment, the advanced index AD_I is the combination COM_3 (i.e., the combination of the slopes S1-S4 of each of the eye diagrams ED_1-ED_M). For each of the slopes S1-S4, the receiver 106 may determine whether each of the slopes S1-S4 is within an angle range ANR, wherein the angle range ANR may be in units of volts per nanosecond (ns), and may be derived by referring to large amounts of data. In response to each of the slopes S1-S4 being within the angle range ANR, the receiver 106 may determine that the eye diagram ED_1 is normal. In response to each of the slopes S1-S4 not being within the angle range ANR, the receiver 106 may determine that the eye diagram ED_1 is not normal.

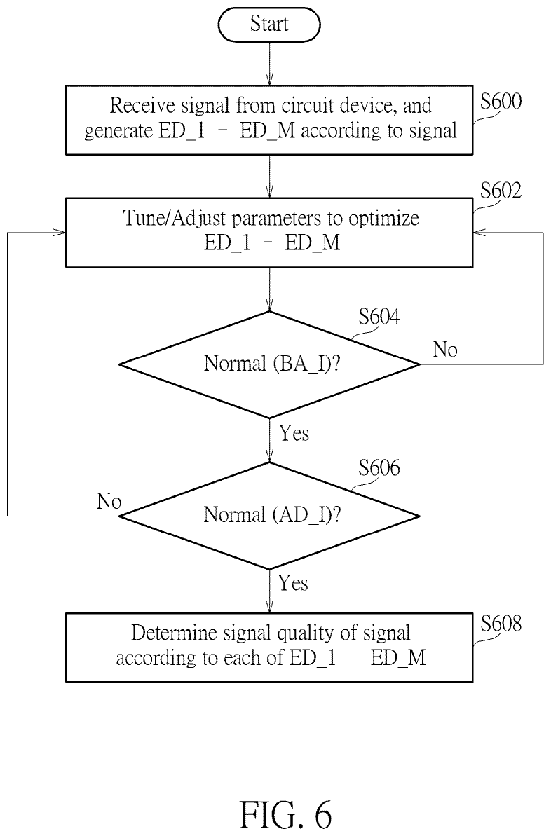

FIG. 6 is a flow chart of a method for determining a signal quality according to an embodiment of the present disclosure. Provided that the result is substantially the same, the steps are not required to be executed in the exact order shown in FIG. 6. For example, the method shown in FIG. 6 may be employed by the receiver 106/108 shown in FIG. 1.

In Step S600, a signal is received from a circuit device. For example, for the receiver 106, the read data REA_D is received from the memory 104. For the receiver 108, the write data WRI_D is received from the memory controller 102. In addition, the eye diagrams ED_1-ED_M are generated according to the signal.

In Step S602, parameters may be tuned/adjusted to optimize the eye diagrams ED_1-ED_M.

In Step S604, it is determined whether each of the eye diagrams ED_1-ED_M is normal according to the basic index BA_I to generate the first determination result F_DR (for brevity, labeled as “Normal (BA_I)?” in FIG. 6), wherein the basic index BA_I is derived from each of the eye diagrams ED_1-ED_M, and includes an eye height and an eye width of each of the eye diagrams ED_1-ED_M. If Yes (i.e., the first determination result F_DR indicating that the eye diagram is normal), Step S606 is entered; if No (i.e., the first determination result F_DR indicating that the eye diagram is not normal), Step S602 is returned to tune/adjust the parameters according to the first determination result F_DR. In some embodiments, in Step S602, when the first determination result F_DR indicates that the eye diagram is not normal, the receiver 106 or the system 100 may issue a warning. For example, the system 100 may display a prompt message on the user interface (e.g., the screen) to indicate that the device at the signal sending end (e.g., the memory 104) may have a problem, so that the user can replace the device according to the prompt.

In Step S606, it is determined whether each of the eye diagrams ED_1-ED_M is normal according to the advanced index AD_I to generate the second determination result S_DR (for brevity, labeled as “Normal (AD_I)?” in FIG. 6), wherein the advanced index AD_I may include at least one of the combination COM_1, the combination COM_2, and the combination COM_3. If Yes (i.e., the second determination result S_DR indicating that the eye diagram is normal), Step S608 is entered; if No (i.e., the second determination result S_DR indicating that the eye diagram is not normal), Step S602 is returned to tune/adjust the parameters according to the second determination result S_DR. In some embodiments, in Step S602, when the second determination result S_DR indicates that the eye diagram is not normal, the receiver 106 or the system 100 may issue a warning. For example, the system 100 may display a prompt message on the user interface (e.g., the screen) to indicate that the device at the signal sending end (e.g., the memory 104) may have a problem, so that the user can replace the device according to the prompt.

In Step S608, the signal quality of the signal (e.g., the data quality of the read data REA_D/write data WER_D) is determined according to each of the eye diagrams ED_1-ED_M.

In some embodiments, the present disclosure is not limited to use in the memory system 100, and may also be applied to other systems with data transmission. For example, the system may have a first circuit and a second circuit. The first circuit may transmit a signal to the second circuit, allowing a receiver in the second circuit to receive the signal from the first circuit and generate multiple eye diagrams based on the received signal, then perform the eye diagram detection action as described above.

Similarly, the second circuit may also transmit a signal to the first circuit, allowing the receiver in the first circuit to receive the signal from the second circuit and generate multiple eye diagrams based on the received signal, then perform the eye diagram detection action as described above.

Since a person skilled in the pertinent art can readily understand details of the steps after reading the above paragraphs, further description is omitted here for brevity.

In summary, by the method and the receiver of the present disclosure, the eye diagrams can be determined to be normal or not to generate a determination result according to both the basic index BA_I and the advanced index AD_I, and the signal quality of the received signal can be effectively and accurately determined according to the determination result. Compared with a case where the signal quality of the received signal is determined only according to a determination result obtained only according to the basic index BA_I, the method and the receiver of the present disclosure can effectively detect the failure of data access operations performed upon the received signal regarding extreme cases (e.g., eye diagrams with irregular shape).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for determining a signal quality, comprising:
receiving a signal from a circuit device;
generating multiple eye diagrams according to the signal;
determining whether each of the multiple eye diagrams is normal according to a basic index to generate a first determination result, wherein the basic index is derived from each of the multiple eye diagrams, and comprises an eye height and an eye width of each of the multiple eye diagrams;
in response to the first determination result indicating that each of the multiple eye diagrams is normal, determining whether each of the multiple eye diagrams is normal according to an advanced index to generate a second determination result, wherein the advanced index is derived from each of the multiple eye diagrams, and comprises at least one of a combination of an area and a contour length of each of the multiple eye diagrams, a combination of a density and a gradient of each of the multiple eye diagrams, and a combination of multiple slopes of each of the multiple eye diagrams; and
in response to the second determination result indicating that each of the multiple eye diagrams is normal, determining the signal quality of the signal according to each of the multiple eye diagrams.

2. The method of claim 1, wherein in response to the advanced index being the combination of the area and the contour length of each of the multiple eye diagrams, the step of determining whether each of the multiple eye diagrams is normal according to the advanced index to generate the second determination result comprises:
mapping each of the multiple eye diagrams to a mapping point on a two-dimensional coordinate system, wherein the two-dimensional coordinate system has a horizontal axis showing one of an area and a contour length, and a vertical axis showing another of the area and the contour length; and
determining whether each of the multiple eye diagrams is normal according to the mapping point and a reference line on the two-dimensional coordinate system, wherein the reference line is formed by connecting multiple predetermined points within the two-dimensional coordinate system.

3. The method of claim 2, wherein the step of determining whether each of the multiple eye diagrams is normal according to the mapping point and the reference line on the two-dimensional coordinate system comprises:
calculating a distance between each of multiple mapping points and the reference line to generate multiple calculation results;
calculating a standard deviation according to the multiple calculation results; and
determining whether each of the multiple eye diagrams is normal according to a corresponding calculation result among the multiple calculation results and the standard deviation.

4. The method of claim 3, wherein the step of determining whether each of the multiple eye diagrams is normal according to the corresponding calculation result among the multiple calculation results and the standard deviation comprises:
determining whether the corresponding calculation result is larger than a threshold value, wherein the threshold value is equal to the standard deviation multiplying by a predetermined constant;
in response to the corresponding calculation result being larger than the threshold value, determining each of the multiple eye diagrams is not normal; and
in response to the corresponding calculation result not being larger than the threshold value, determining each of the multiple eye diagrams is normal.

5. The method of claim 1, wherein in response to the advanced index being the combination of the density and the gradient of each of the multiple eye diagrams, the step of determining whether each of the multiple eye diagrams is normal according to the advanced index to generate the second determination result comprises:
mapping each of the multiple eye diagrams to a two-dimensional coordinate system, and performing a division operation upon the two-dimensional coordinate system according to a predetermined time interval and multiple predetermined voltage amplitude values to obtain a data array, wherein the two-dimensional coordinate system has a horizontal axis showing one of a time and a voltage amplitude, and a vertical axis showing another of the time and the voltage amplitude;
setting a value of each data within the data array as a first level or a second level according to whether a data access operation performed upon each data fails, wherein the first level is different from the second level;
calculating a density value of each data within the data array according to multiple values of data within the data array, wherein the multiple values comprise the value;
calculating a gradient value according to multiple density values, wherein the multiple density values comprise the density value, and the gradient value is a slope of the multiple density values; and
determining whether each of the multiple eye diagrams is normal according to the gradient value.

6. The method of claim 5, wherein the data array is located at a boundary area of each of the multiple eye diagrams, and the multiple density values comprise at least one density value within the boundary area and at least one density value out of the boundary area.

7. The method of claim 5, wherein the step of calculating the density value of each data within the data array according to the multiple values of the data within the data array comprises:
performing an average operation upon the multiple values to generate the density value of each data, wherein the multiple values comprise the value and another values of multiple adjacent data with respect to each data, and the multiple adjacent data are within the data array.

8. The method of claim 5, wherein the step of setting the value of each data as the first level or the second level according to whether the data access operation performed upon each data fails comprises:
in response to the data access operation performed upon each data not failing, setting the value of each data as the first level; and
in response to the data access operation performed upon each data failing, setting the value of each data as the second level.

9. The method of claim 5, wherein the step of determining whether each of the multiple eye diagrams is normal according to the gradient value comprises:
in response to the gradient value indicating that a variation amplitude of the multiple density values is larger than a threshold value, determining each of the multiple eye diagrams is normal; and
in response to the gradient value indicating that the variation amplitude of the multiple density values is not larger than the threshold value, determining each of the multiple eye diagrams is not normal.

10. The method of claim 1, wherein the multiple slopes correspond to multiple rising times and multiple falling times of each of the multiple eye diagrams; and in response to the advanced index being the combination of the multiple slopes of each of the multiple eye diagrams, the step of determining whether each of the multiple eye diagrams is normal according to the advanced index to generate the second determination result comprises:
for each of the multiple slopes, determining whether each of the multiple slopes is within an angle range;
in response to each of the multiple slopes being within the angle range, determining each of the multiple eye diagrams is normal; and
in response to each of the multiple slopes not being within the angle range, determining each of the multiple eye diagrams is not normal.

11. A receiver, arranged to:
receive a signal from a circuit device;
generate multiple eye diagrams according to the signal;
determine whether each of the multiple eye diagrams is normal according to a basic index to generate a first determination result, wherein the basic index is derived from each of the multiple eye diagrams, and comprises an eye height and an eye width of each of the multiple eye diagrams;
in response to the first determination result indicating that each of the multiple eye diagrams is normal, determine whether each of the multiple eye diagrams is normal according to an advanced index to generate a second determination result, wherein the advanced index is derived from each of the multiple eye diagrams, and comprises at least one of a combination of an area and a contour length of each of the multiple eye diagrams, a combination of a density and a gradient of each of the multiple eye diagrams, and a combination of multiple slopes of each of the multiple eye diagrams; and
in response to the second determination result indicating that each of the multiple eye diagrams is normal, determine the signal quality of the signal according to each of the multiple eye diagrams.

12. The receiver of claim 11, wherein in response to the advanced index being the combination of the area and the contour length of each of the multiple eye diagrams, the receiver is further arranged to:
map each of the multiple eye diagrams to a mapping point on a two-dimensional coordinate system, wherein the two-dimensional coordinate system has a horizontal axis showing one of an area and a contour length, and a vertical axis showing another of the area and the contour length; and
determine whether each of the multiple eye diagrams is normal according to the mapping point and a reference line on the two-dimensional coordinate system, wherein the reference line is formed by connecting multiple predetermined points within the two-dimensional coordinate system.

13. The receiver of claim 12, wherein the receiver is further arranged to:
calculate a distance between each of multiple mapping points and the reference line to generate multiple calculation results;
calculate a standard deviation according to the multiple calculation results; and
determine whether each of the multiple eye diagrams is normal according to a corresponding calculation result among the multiple calculation results and the standard deviation.

14. The receiver of claim 13, wherein the receiver is further arranged to:
determine whether the corresponding calculation result is larger than a threshold value, wherein the threshold value is equal to the standard deviation multiplying by a predetermined constant;
in response to the corresponding calculation result being larger than the threshold value, determine each of the multiple eye diagrams is not normal; and
in response to the corresponding calculation result not being larger than the threshold value, determine each of the multiple eye diagrams is normal.

15. The receiver of claim 11, wherein in response to the advanced index being the combination of the density and the gradient of each of the multiple eye diagrams, the receiver is further arranged to:
map the multiple eye diagrams to a two-dimensional coordinate system, and perform a division operation upon the two-dimensional coordinate system according to a predetermined time interval and multiple predetermined voltage amplitude values to obtain a data array, wherein the two-dimensional coordinate system has a horizontal axis showing one of a time and a voltage amplitude, and a vertical axis showing another of the time and the voltage amplitude;
set a value of each data within the data array as a first level or a second level according to whether a data access operation performed upon each data fails, wherein the first level is different from the second level;
calculate a density value of each data within the data array according to multiple values of data within the data array, wherein the multiple values comprise the value;
calculate a gradient value according to multiple density values, wherein the multiple density values comprise the density value, and the gradient value is a slope of the multiple density values; and
determine whether each of the multiple eye diagrams is normal according to the gradient value.

16. The receiver of claim 15, wherein the data array is located at a boundary area of each of the multiple eye diagrams, and the multiple density values comprise at least one density value within the boundary area and at least one density value out of the boundary area.

17. The receiver of claim 15, wherein the receiver is further arranged to:
perform an average operation upon the multiple values to generate the density value of each data, wherein the multiple values comprise the value and another values of multiple adjacent data with respect to each data, and the multiple adjacent data are within the data array.

18. The receiver of claim 15, wherein the receiver is further arranged to:
in response to the data access operation performed upon each data not failing, set the value of each data as the first level; and
in response to the data access operation performed upon each data failing, set the value of each data as the second level.

19. The receiver of claim 15, wherein the receiver is further arranged to:
in response to the gradient value indicating that a variation amplitude of the multiple density values is larger than a threshold value, determine each of the multiple eye diagrams is normal; and
in response to the gradient value indicating that the variation amplitude of the multiple density values is not larger than the threshold value, determine each of the multiple eye diagrams is not normal.

20. The receiver of claim 11, wherein the multiple slopes correspond to multiple rising times and multiple falling times of each of the multiple eye diagrams; and in response to the index being the combination of the multiple slopes of each of the multiple eye diagrams, the receiver is further arranged to:
for each of the multiple slopes, determine whether each of the multiple slopes is within an angle range;
in response to each of the multiple slopes being within the angle range, determine each of the multiple eye diagrams is normal; and
in response to each of the multiple slopes not being within the angle range, determine each of the multiple eye diagrams is not normal.
